(19) United States
(12) Patent Application Publication
(10) Pub. No.: US 2020/0172669 A1
(43) Pub. Date: Jun. 4, 2020

(54) Crosslinkable Aromatic Polymer Compositions for Use in Additive Manufacturing Processes and Methods for Forming the Same

(71) Applicant: Greene, Tweed Technologies, Inc., Wilmington, DE (US)

(72) Inventors: Le Song, Chalfont, PA (US); Mithun Bhattacharya, North Wales, PA (US); Tim Greene, Safety Harbor, FL (US); Kerry A. Drake, Red Hill, PA (US); Emile Homsi, Sicklerville, NJ (US); Eric Romano, Wilmington, DE (US)

(73) Assignee: Greene, Tweed Technologies, Inc.

(21) Appl. No.: 16/568,125

(22) Filed: Sep. 11, 2019

Related U.S. Application Data
(60) Provisional application No. 62/729,999, filed on Sep. 11, 2018.
(60) Provisional application No. 62/730,000, filed on Sep. 12, 2018.

(51) Int. Cl. C08G 65/40; C08K 3/16; C08K 5/10; B29C 64/153; B29C 64/118; B29C 64/205

(52) U.S. Cl. CPC C08G 65/4012; C08K 3/16; C08K 5/10; B29C 64/153; B33Y 10/00; B29C 64/205; C08G 2650/20; C08G 2650/40; C08K 2003/166; B29C 64/118

(57) ABSTRACT

The present invention discloses crosslinkable polymer compositions and additive manufacturing compositions incorporating such crosslinkable polymer compositions for use in additive manufacturing methods to prepare articles. The polymer compositions include at least one aromatic polymer and at least one crosslinking compound that is capable of crosslinking the at least one aromatic polymer.

### CROSS-REFERENCE TO RELATED APPLICATIONS

This U.S. non-provisional patent application claims the benefit under 35 U.S.C. § 119(e) to U.S. provisional patent application No. 62/729,999, filed Sep. 11, 2018, entitled, “Crosslinkable Aromatic Polymer Compositions for Use in Additive Manufacturing Processes and Methods for Forming the Same,” and further claims the benefit under 35 U.S.C. § 119(e) to U.S. provisional patent application No. 62/730,000, filed Sep. 12, 2018, entitled, “Cross-Linking Compositions for Forming Cross-Linked Organic Polymers, Organic Polymer Compositions, Methods of Forming the Same, and Molded Articles Produced Therefrom,” the entire disclosures of which are incorporated herein by reference.

### BACKGROUND OF THE INVENTION

### Field of the Invention

The present invention relates to polymer compositions useful in additive manufacturing. Specifically, the present invention relates to crosslinkable aromatic polymer compositions including aromatic polymers and a crosslinking compound capable of crosslinking the aromatic polymers, that when used in additive manufacturing methods produces articles in a layer-by-layer manner, which have improved adhesion between layers and improved isotropy relative to articles printed or otherwise formed by conventional materials presently used in additive manufacturing.

### Description of Related Art

Additive manufacturing, also commonly referred to as three-dimensional (“3D”) printing is increasing in popularity for rapid prototyping and commercial production of articles. Various types of additive manufacturing processes are known, including vat photopolymerization methods such as stereolithography (“SLA”), material or binder jetting methods, powder bed fusion methods such as selective laser sintering (“SLS”), and material extrusion methods such as fused deposition modeling (“FDM”), fused-filament fabrication (“FFF”) and direct pellet extrusion, among others.

In vat photopolymerization methods, a liquid photopolymer resin is stored in a vat in which a build platform is positioned. An article can be formed based on a computer model of the article in which the article is represented as a series of layers or cross sections. Based on the computer model, a first layer of the article is formed using UV light to selectively cure the liquid photopolymer resin. Once the first layer is formed, the build platform is lowered and the UV light is used to cure the liquid photopolymer resin so as to form a subsequent layer of the article on top of the first layer. This process is repeated until the printed article is formed.

In material jetting methods, an article is prepared in a layer-by-layer manner by depositing drops of a liquid material, such as a thermoset photopolymer, to form a first layer of the article based on a computer model of the article. The deposited layer of liquid material is cured or solidified, such as by the application of UV light. Subsequent layers are deposited in the same manner so as to produce a printed article. In binder jetting, an article is formed by depositing a layer of a powdered material on a build platform and selectively depositing a liquid binder to join the powder. Subsequent layers of powder and binder are deposited in the same manner and the binder serves as an adhesive between powder layers.

In powder bed fusion methods, and specifically SLS, an article is formed by generating a computer model of the article to be printed in which the article is represented as a series of layers or cross-sections. To prepare the article, a layer of powder is deposited on a build platform and the powder is sintered by the use of a laser to form a layer of the article based on the computer model. Once the layer is sintered, a further layer of powder is deposited and sintered. This process is repeated as necessary to form the article having the desired configuration.

In material extrusion methods, such as FDM or FFF, a computer model of an article is generated in which the article is represented as a series of layers. The article is produced by feeding a filament of material to an extruding head which heats the filament and deposits the heated filament on a substrate to form a layer of the article. Once a layer is formed, the extruding head proceeds to deposit the next layer of the article based upon the computer model of the article. This process is repeated in a layer-by-layer manner until the printed article is fully formed. Similarly, in direct pellet extrusion, pellets rather than filaments are used as the feed material, and the pellets are fed to an extruding head and are heated and deposited onto the substrate.

A variety of polymeric materials are known for use in additive manufacturing methods. Common polymeric materials used in additive manufacturing include acrylonitrile butadiene styrene (ABS), polyurethane, polyamide, polystyrene, and polylactic acid (PLA). More recently, high performance engineering thermoplastics have been used to produce printed articles with improved mechanical and chemical properties relative to common polymer materials. Such high performance thermoplastics include, polyaryletherketones, polyphenylsulfones, polycarbonates, and polyetherimides.

While additive manufacturing methods can be used to rapidly form an article having any of various shapes and configurations, articles formed by additive manufacturing processes generally suffer from weak adhesion between layers in the z-direction of the printed article. For example, U.S. Patent Application Publication No. 2013/0217838, which related to use of recycled PAEK already used in an SLS process, describes the disadvantages of manufacturing articles from polyaryletherketones using SLS due to poor mechanical performance of the articles in the z-direction of the articles, resulting in anisotropic mechanical properties of the resulting articles.

While attempts have been made to utilize high performance thermoplastic materials in additive manufacturing and to improve the adhesion between layers of the printed article, there remains a need for additive manufacturing materials that demonstrate improved interlayer adhesion and strength in the z-direction of the article. Further, materials are desired that are capable of use in any of various additive manufacturing processes that provide improved chemical and mechanical properties relative to conventional polymer materials used in additive manufacturing.

### BRIEF SUMMARY OF THE INVENTION

The invention includes a crosslinkable polymer composition for use in an additive manufacturing methods, comprising: at least one aromatic polymer, and at least one crosslinking compound capable of crosslinking the at least one aromatic polymer.

The at least one aromatic polymer may be selected from poly(arylene ether)s, polysulfones, polyethersulfones, polyimides, polyamides, polyetherketones, polyphenylene sulfides, polyureas, polyurethanes, polyphthalamide, polyamide-imides, polybenzimidazoles, polyaramids, and blends thereof. The at least one aromatic polymer may further be a poly(arylene ether) including polymer repeating units along its backbone having the structure according to formula (I):

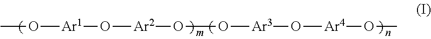

wherein Ar¹, Ar², Ar³ and Ar⁴ are identical or different aryl radicals, m=0 to 1, and n=1−m. In addition it is possible for at least one aromatic polymer has repeating units along its backbone having the structure of formula (II):

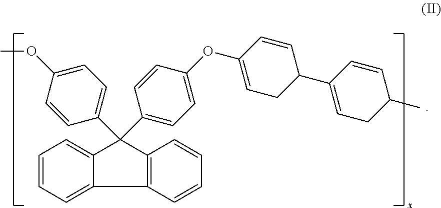

The at least one aromatic polymer may preferably be a polyarylene ether or a polyaryletherketone. For example, the aromatic polymer may be polyaryletherketone selected from the group of polyetherketone, polyetheretherketone, polyetherketoneketone, and polyetherketoneetherketoneketone.

The at least one crosslinking compound may have a structure according to one of the following formulae:

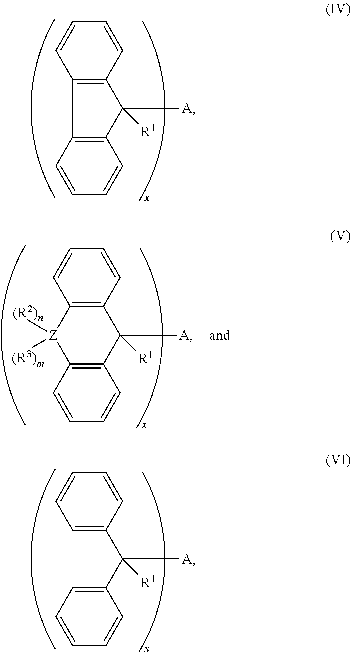

wherein A is bond, an alkyl, an aryl, or an arene moiety having a molecular weight less than about 10,000 g/mol; wherein R¹, R², and R³ are the same or different and are independently selected from the group consisting of hydrogen, hydroxyl (—OH), amine (NH₂), halide, ester, ether, amide, aryl, arene, or a branched or straight chain, saturated or unsaturated alkyl group of one to about six carbon atoms; wherein m is from 0 to 2, n is from 0 to 2, and m+n is greater than or equal to zero and less than or equal to two; wherein Z is selected from the group of oxygen, sulfur, nitrogen, and a branched or straight chain, saturated or unsaturated alkyl group of one to about six carbon atoms; and wherein xis about 1 to about 6.

In one embodiment, the at least one crosslinking compound has a structure according to formula (IV) and is selected from the group consisting of:

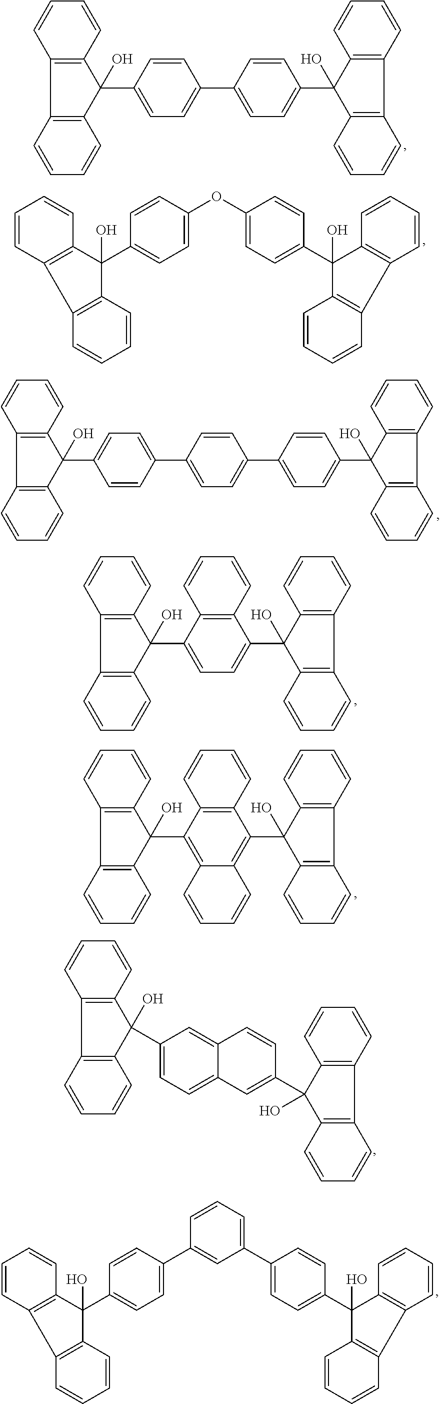

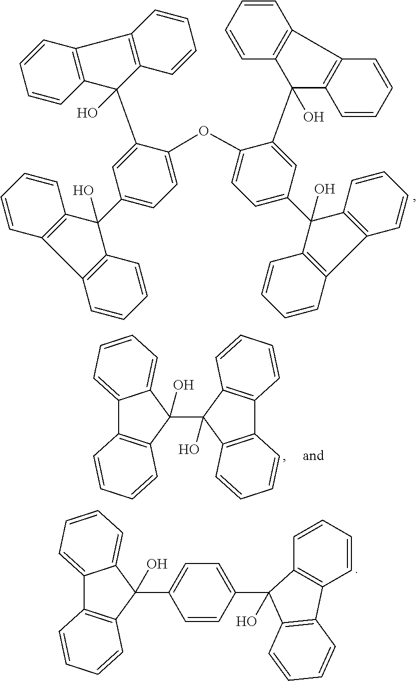

The at least one crosslinking compound may have a structure according to formula (V) and is selected from a group consisting of:

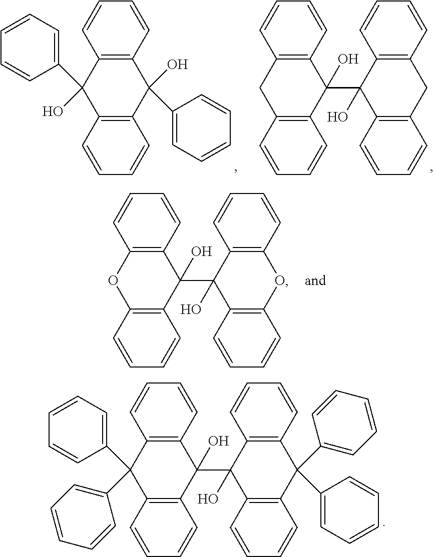

The at least one crosslinking compound has a structure according to formula (VI) and is selected from the group consisting of:

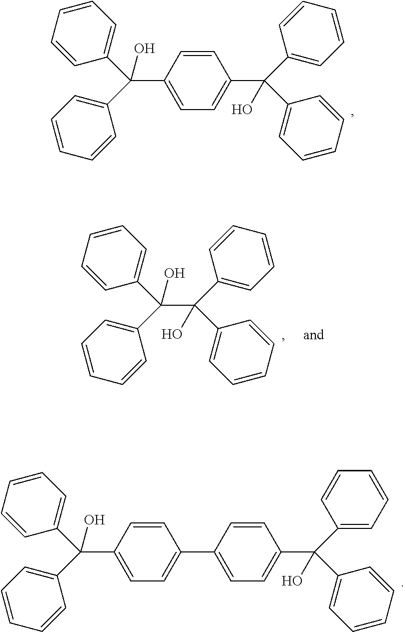 [SMILES: OC(c1ccccc1)(c1ccccc1)c1ccc(C(O)(c2ccccc2)c2ccccc2)cc1 ; OC(c1ccccc1)(c1ccccc1)C(O)(c1ccccc1)c1ccccc1 ; OC(c1ccccc1)(c1ccccc1)c1ccc(-c2ccc(C(O)(c3ccccc3)c3ccccc3)cc2)cc1]

In a preferred embodiment, A has a molecular weight of about 1,000 g/mol to about 9,000 g/mol, and preferably A has a molecular weight of about 2,000 g/mol to about 7,000 g/mol.

Preferably, the least one crosslinking compound is present in the crosslinkable polymer composition in an amount of about 1% by weight to about 50% by weight of an unfilled weight of the crosslinkable polymer composition. A weight ratio of the aromatic polymer to the crosslinking compound is preferably about 1:1 to about 100:1, and more preferably the weight ratio of the aromatic polymer to the crosslinking compound is about 3:1 to about 10:1.

The composition may further comprise a crosslinking reaction additive selected from a cure inhibitor and a cure accelerator. The crosslinking reaction additive may be present in an amount of 0.01% to 5% by weight of the crosslinking compound. The crosslinking reaction additive may be a cure inhibitor such as lithium acetate. The crosslinking reaction additive may also be a cure accelerator such as magnesium chloride.

One or more additives may be added to the composition such as those selected from continuous or discontinuous, long or short, reinforcing fibers selected from carbon fibers, glass fibers, woven glass fibers, woven carbon fibers, aramid fibers, boron fibers, polytetrafluoroethylene fibers, ceramic fibers, polyamide fibers; and/or one or more fillers selected from carbon black, silicate, fiberglass, calcium sulfate, boron, ceramic, polyamide, asbestos, fluorographite, aluminum hydroxide, barium sulfate, calcium carbonate, magnesium carbonate, silica, aluminum nitride, borax (sodium borax), activated carbon, pearlite, zinc terephthalate, graphite, graphene, talc, mica, silicon carbide whiskers or platelets, nanofillers, molybdenum disulfide, fluoropolymer fillers, carbon nanotubes and fullerene tubes. The polymer composition in such an embodiment may comprise about 0.5% by weight to about 65% by weight of the one or more additives and/or one or more fillers.

The compositions noted above when formed into articles result in a lower viscosity and a reduced crystallization rate in comparison to the same aromatic polymers when uncrosslinked, which provides improved processability for the materials when used in additives manufacturing processes such as three-dimensional printing. Further, once postcured, articles formed by the compositions herein result in improved adhesive bonding between layers when formed by printed filaments or by injection molding

The invention further includes an article printed by an additive manufacturing process using the crosslinkable polymer composition as described above and elsewhere herein. Such an article preferably has improved interlayer adhesion relative to an article formed by an aromatic polymer having the same backbone structure that is not crosslinked. The article preferably also has improved isotropy in mechanical properties relative to an article formed by an aromatic polymer having the same backbone structure that is not crosslinked. In one embodiment, the article is formed by selective laser sintering. In a further embodiment, the article is formed by fused filament fabrication.

The invention further incorporates an additive manufacturing composition for use in an additive manufacturing process, wherein the composition comprises a crosslinkable aromatic polymer composition comprising at least one aromatic polymer and at least one crosslinking compound capable of crosslinking the at least one aromatic polymer.

Also included herein is a method for preparing a crosslinkable polymer composition for use in an additive manufacturing method, comprising: providing at least one aromatic polymer, and at least one crosslinking compound capable of crosslinking the at least one aromatic polymer; and combining the at least one aromatic polymer and the at least one crosslinking compound. The method may further comprise combining the aromatic polymer and the crosslinking compound so the crosslinkable polymer composition is substantially homogeneous. In another embodiment, the method may further comprise combining the aromatic polymer and the crosslinking compound by mechanical blending. In yet a further embodiment, the method may comprise: dissolving the aromatic polymer and the crosslinking compound in a common solvent; and removing the common solvent by evaporation or by addition of a non-solvent so as to cause precipitation of the aromatic polymer and the crosslinking compound out of the common solvent.

The invention also includes a crosslinked aromatic polymer for use in an additive manufacturing process to form articles which is a reaction product of at least one aromatic polymer and at least one crosslinking compound capable of crosslinking the aromatic polymer. In one embodiment the at least one aromatic polymer is selected from the group of poly(arylene ether)s, polysulfones, polyethersulfones, polyimides, polyamides, polyetherketones, polyphenylene sulfides, polyureas, polyurethanes, polyphthalamides, polyamide-imides, polybenzimidazoles, polyaramids, and blends thereof. The crosslinking compound has a structure according to one of the following formulae:

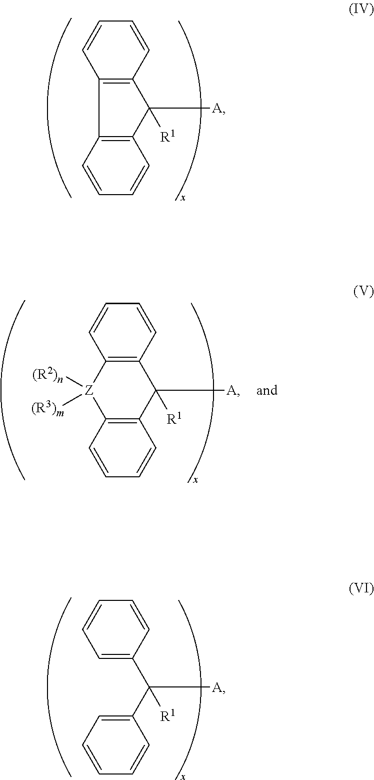

wherein A is bond, an alkyl, an aryl, or an arene moiety having a molecular weight less than about 10,000 g/mol; wherein R¹, R², and R³ are the same or different and are independently selected from the group consisting of hydrogen, hydroxyl (—OH), amine (NH₂), halide, ester, ether, amide, aryl, arene, or a branched or straight chain, saturated or unsaturated alkyl group of one to about six carbon atoms; wherein m is from 0 to 2, n is from 0 to 2, and m+n is greater than or equal to zero and less than or equal to two; wherein Z is selected from the group of oxygen, sulfur, nitrogen, and a branched or straight chain, saturated or unsaturated alkyl group of one to about six carbon atoms; and wherein x is about 1 to about 6.

The invention also includes a method of preparing an article by an additive manufacturing process, comprising: providing the crosslinkable polymer composition of claim 1; and introducing the crosslinkable polymer composition into an additive manufacturing process to prepare a printed article. The additive manufacturing process may be a powder bed fusion method. The additive manufacturing process may be a material extrusion method.

A method of improving adhesion between layers in an article prepared by an additive manufacturing process is also included herein which comprises: providing a crosslinkable aromatic polymer composition comprising at least one aromatic polymer and at least one crosslinking compound capable of crosslinking the at least one aromatic polymer; introducing the crosslinkable aromatic polymer composition into an additive manufacturing process to prepare a printed article; and applying heat to the crosslinkable aromatic polymer composition during and/or after the additive manufacturing process to induce crosslinking of the aromatic polymer by the crosslinking compound.

The invention further includes a method of improving isotropy in mechanical properties of an article prepared by an additive manufacturing process, comprising: providing a crosslinkable aromatic polymer composition comprising at least one aromatic polymer and at least one crosslinking compound capable of crosslinking the at least one aromatic polymer; introducing the crosslinkable aromatic polymer composition into an additive manufacturing process to prepare a printed article; and applying heat to the crosslinkable aromatic polymer composition during and/or after the additive manufacturing process to induce crosslinking of the aromatic polymer by the crosslinking compound.

### BRIEF DESCRIPTION OF THE SEVERAL VIEWS OF THE DRAWING(S)

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown. In the drawings:

FIG. 1 is a representative illustration of the behavior of polymers when printing layers in additive manufacturing for (a) an amorphous polymer; (b) a semicrystalline aromatic polymer such as a PAEK; and (c) a crosslinked aromatic polymer according to the invention;

FIG. 2 is a graphical representation of the adhesive strength of a crosslinked polyarylene (Arlon 3000XT™) normalized to an uncrosslinked PEEK against bonding pressure as described in Example 1;

FIG. 3 is a photographic images of crosslinked polyarylene filament formed in according with Example 2;

FIG. 4 is are photographic images specimens after a double cantilever beam (DCB) test from Example 4, wherein the top specimen is formed of Standard FFF PEEK and the bottom test specimen is formed of the crosslinkable formula of Example 4 using Arlon 3000XT™;

FIG. 5 shows two-dimensional CT scan images of the three-dimensionally printed PEEK and Arlon 3000XT™ bars of Example 4 before and after the post-cure cycle, wherein the photo on the left shows PEEK (A) and crosslinkable Arlon 3000 (B) before post-curing, and the photo on the right shows the PEEK (A) and Arlon 3000XT™ after post-curing;

FIG. 6 is a photographic image of bars from Example 5, wherein the bars on the left represent the FFF printed PAEK bars, and the bars on right are the crosslinkable PAEK bars formed using filaments prepared under the conditions referenced in Examples 1 and 2

FIG. 7 is a graphical representation of a rheological curve plotting complex viscosity against time for crosslinkable PAEK and standard PAEK from Example 6;

FIG. 8 is a graphical representation of a DSC cooling curve for the crosslinkable PAEK and the standard PAEK from Example 6; and

FIG. 9 is a graphical representation of a DSC heating curve for the crosslinkable PAEK and the standard PAEK from Example 6.

### DETAILED DESCRIPTION OF THE INVENTION

The present invention discloses crosslinkable polymer compositions useful for and in additive manufacturing methods, additive manufacturing compositions incorporating such crosslinkable polymer compositions and articles formed from such compositions. Also included herein are methods for forming such crosslinkable polymer compositions, and the crosslinked polymer compositions. The crosslinkable polymer compositions of the present invention should not be considered to be limited to a single use in only a specific type of additive manufacturing or other three-dimensional printing process. As used herein generally, “additive manufacturing” is intended to broadly include the various additive manufacturing processes noted in the Background section hereof, and any other three-dimensional printing process.” The crosslinkable polymers and related compositions of the present invention should be considered to be useful for or in any additive manufacturing methods know or to be developed in the relevant art. The crosslinkable polymer compositions herein and related inventions are particularly suited for use in material extrusion methods, such as fused deposition modeling or fused filament fabrication, and in powder bed fusion methods, such as selective laser sintering processes, among others. The crosslinkable polymer compositions can be used in additive manufacturing methods for rapid prototyping, and are more preferably used for commercial scale production of parts.

The crosslinkable polymer compositions may be used in additive manufacturing in various, non-limiting physical forms as well. For example, the crosslinkable polymer compositions may be provided in any of a variety of physical forms to be selected based upon the intended end use implementation in a particular type of additive manufacturing process into which the crosslinkable polymer composition is employed. For example, in SLS processes, the crosslinkable polymer composition may be provided in a powder form, which powder form may have a range of particle sizes, varying polydispersity, and varying surface area. When used in FFF or FDM methods, the crosslinkable polymer composition may be provided in filament form. The crosslinkable polymer composition may also be provided in pellet form for direct pellet extrusion.

When used in an additive manufacturing process to form a printed article, the crosslinkable polymer composition of the present invention provides improved adhesion between layers of the article resulting from the process. The improved adhesion between layers can extend in different directions, but is notably and primarily realized in the z-direction of the printed article. As a result, printed articles produced using the crosslinkable polymer compositions of the present invention have improved isotropy in mechanical properties, such as tensile strength and modulus relative to conventional, unmodified polymeric materials.

Further, the crosslinked aromatic polymers of the present invention have relatively low coefficients of thermal expansion and improved thermal management relative to unmodified polymers. The lower coefficient of thermal expansion and the resulting improvement in thermal management, especially at high temperatures, may facilitate additive manufacturing using material extrusion methods, such as FDM or FFF.

Without wishing to be bound by theory it is believed that the crosslinker and catalyst used herein “tie” the adjacent layers, i.e., through interdiffusion of the polymers and catalyst molecules across the additive manufacturing layers, nodal points are provided which tightly knit the molecular structure, not just in a planar direction, but also out of the plane. Subsequent and further crosslinking can be used to increase the adhesion. Thus, through interlayer diffusion of the polymer as well as crosslinking and chemical bonding between layers, through the cure reaction of the compositions, both during the additive manufacturing steps and after post-process treatment, improved properties in varied directions, including the z-direction can be achieved.

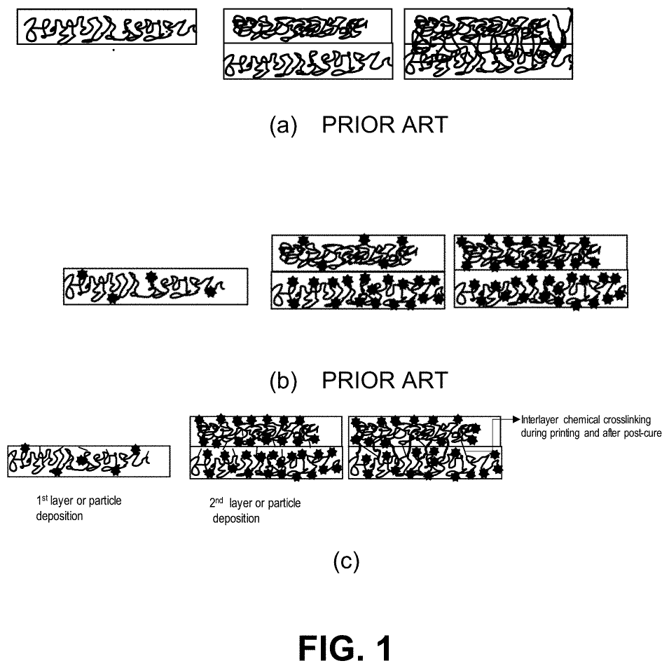

When printing amorphous polymers, there is little if any interlaminar bonding. The only bonding that can take place is interparticle adhesion through thermal diffusion/chain reptation (See, De Gennes, P. G. “Reptation of a Polymer Chain in the Presence of Fixed Obstacles, The Journal of Chemical Physics, vol. 55 (2), pp. 572 (1971). This interparticle bonding is expected to be very limited at temperatures below the glass transition temperature (T_{g}) of the polymers. However, with respect to amorphous polymers, once they are heated above their T_{g}, they will melt and flow. This is a limitation and a problem in additive manufacturing such as three-dimensional printing. That is illustrated in FIG. 1, a schematic (a) is provided as a representative illustration of two printed layers of polymer. Note that interdiffusion over time will be limited if T<T_{g}.

In semicrystalline materials, such as most polyaryl ether ketones (PAEKs) and other polyarylenes, during a three-dimensional printing process, crystallites can form after extrusion or heating of the polymer. The crystallites act as physical cross-links and thus inhibit interparticle diffusion to enhance adhesion across layers. As shown in FIG. 1, a schematic (b) is provided as a representative illustration of interparticle/interlayer adhesion. The chain thermal diffusion is limited by crystallization (limited bridging of polymer chains across layers and between particles.) Prior art PAEK printed articles are also known to have difficulty with respect to reduced interlaminar properties and can demonstrate significant anisotropy relative to printing orientation.

When incorporating crosslinklable polymers, such as crosslinkable PAEKs within the scope of the present invention, the materials have reduced rates of crystallization, lower melt viscosity, and the ability to crosslink across layers, significantly improved bonding across layers may be achieved. This is illustrated in FIG. 1 with reference to schematic (c) which is a representative illustration of interparticle/interlayer adhesion. Schematic (c) illustrates a better chain, thermal diffusion than achieved using semi-crystalline materials. Further, better chemical bonding occurs during printing, and more thermal diffusion and chemical bonding occurs in post-curing of the printed article. This results in improved interlaminar adhesion, as well as improved isotropy in the printed article.

This will result in improved interlaminar adhesion, as well as improved isotropy. Current PAEK formulas suffer from reduced interlaminar properties as well as show significant anisotropy relative to printing orientation.

The crosslinkable polymer compositions include an aromatic polymer that can be crosslinked. The crosslinking of an aromatic polymer can be achieved by modification of the polymer for grafted crosslinking, exposure of an aromatic polymer to sufficiently high temperatures to induce self-crosslinking of the polymer, and/or by the use of a separate crosslinking compound. The aromatic polymer may be crosslinked, for example, by grafting functional groups onto the polymer backbone which can be thermally induced to crosslink the polymers, as further described in U.S. Pat. No. 6,060,170, incorporated in relevant part herein by reference. Alternatively, the aromatic polymer may be crosslinked by thermal action at temperatures greater than about 350° C. or more, as disclosed in U.S. Pat. No. 5,658,994 incorporated in relevant part herein by reference. An example of a preferred material for use in thermal crosslinking is 1,2,4,5 tetra(phenylethynyl)benzene as shown below:

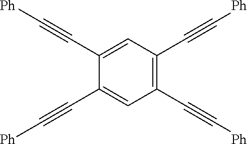 [SMILES: C(#Cc1cc(C#Cc2ccccc2)c(C#Cc2ccccc2)cc1C#Cc1ccccc1)c1ccccc1]

In a preferred embodiment of the present application, the crosslinkable polymer compositions of the present invention include an aromatic polymer and a crosslinking compound capable of crosslinking the aromatic polymer either across chains or to itself within the polymer matrix.

The aromatic polymer of the crosslinkable polymer composition may be any of a polyarylenes, including polyarylene ethers, such as polyetherketone, polyetherketone, polyetherketone ketone and the like; polysulfone; polyethersulfone; polyphenylene sulfide;

polyimide; polyetherimide; polyamide; polyamide-imide; polyuria; polyurethane; polyphthalamide; polybenzimidazole; polyaramid or similar aromatic polymers known in the art or to be developed including various copolymers and functionalized or derivatized versions of such polymers. The aromatic polymer may be functionalized or non-functionalized as desired to achieve specific properties or as necessary for specific applications, e.g., functional groups such as hydroxyl, mercapto, amine, amide, ether, ester, halogen, sulfonyl, aryl and functional aryl groups or other functional groups can be provided depending intended end effects and properties. The aromatic polymer can also be a polymer blend, alloy, or co-polymer or other multiple monomer polymerization of two or more of such aromatic polymers. Preferably, when the aromatic polymer is a blend or alloy, the aromatic polymers are chosen so as to be processible at in a compatible processing temperature range.

In an embodiment of the crosslinkable polymer compositions herein, the aromatic polymer may be a poly(arylene ether) including polymer repeating units along its backbone having a structure according to formula (I):

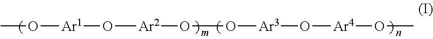

wherein Ar¹, Ar², Ar³ and Ar⁴ are identical or different aryl radicals, m=0 to 1, and n=1−m, wherein such polymers may be of a variety of molecular weights and chain lengths depending on intended end use as is known in the relevant aromatic polymer art.

In a further embodiment, the aromatic polymer may be a poly(arylene ether) as in formula (I), wherein m is 1 and n is 0, and the aromatic polymer has repeating units along its backbone having a structure as shown below in formula (II):

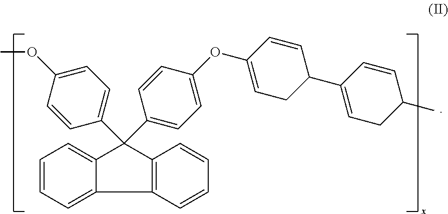

Such polymers may be obtained commercially for example, as Ultura™ from Greene, Tweed, Kulpsville, Pa.

In a preferred embodiment, the aromatic polymer is a polyaryletherketone (PAEK), such as polyetherketone (PEK), polyetheretherketone (PEEK), polyetherketoneketone (PEKK), and polyetherketoneetherketoneketone (PEKEKK). The aromatic polymer may be a commercially available aromatic polymer.

The crosslinking compounds of the crosslinkable polymer compositions of the present invention are capable of crosslinking an aromatic polymer. Suitable crosslinking compounds for crosslinking organic polymers are described in applicant's U.S. Pat. No. 9,006,353, incorporated herein by reference in relevant part, describing a composition having a crosslinking compound of the general structure:

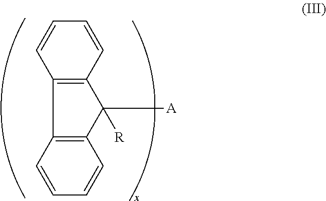

wherein R is OH, NH₂, halide, ester, amine, ether or amide, and x is 1 to 6 and A is an arene moiety having a molecular weight of less than about 10,000 g/mol. When reacted with an aromatic polymer, such as a polyarylene ketone, such crosslinking compound forms a thermally stable, cross-linked oligomer or polymer. Such crosslinking technology enabled aromatic polymers that were believed in the art to be difficult to crosslink, to be formed in a crosslinkable form so as to be thermally stable up to temperatures greater than 260° C. and even greater than 400° C. or more, depending on the polymer so modified, i.e., polysulfones, polyimides, polyamides, polyetherketones and other polyarylene ketones, polyphenylene sulfides, polyureas, polyurethanes, polyphthalamides, polyamide-imides, aramids, and polybenzimidazoles.

Additional crosslinking compounds for crosslinking aromatic polymers include crosslinking compounds according to any of the following structures:

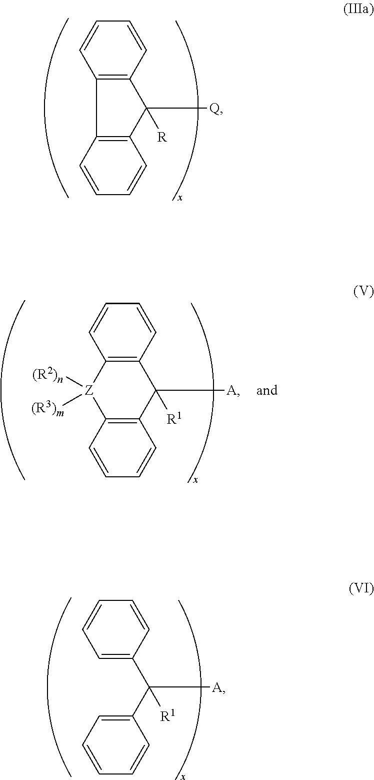

wherein Q is a bond and A is Q, an alkyl, an aryl, or an arene moiety having a molecular weight less than about 10,000 g/mol. Each of R¹, R², and R³ are the same or different and are independently selected from the group consisting of hydrogen, hydroxyl (—OH), amine (—NH₂), halide, ester, ether, amide, aryl, arene, or a branched or straight chain, saturated or unsaturated alkyl group of one to about six carbon atoms. Formula (IIIa) is substantially the same as formula (III) above, with the exception that the moiety A in formula (III) is replaced by Q (which represents a bond) and R¹ of formula (IIIa) is defined differently than R of formula (III).

In formula (V), m is from 0 to 2, n is from 0 to 2, and m+n is greater than or equal to zero and less than or equal to two. Further, in formula (V), Z is selected from the group of oxygen, sulfur, nitrogen, and a branched or straight chain, saturated or unsaturated alkyl group of one to about six carbon atoms. In any of formulae (IIIa), (V) and (VI), as with formula (III), x is also about 1 to about 6.

With respect to the selection of crosslinking compounds of formulae (IIIa), (V) and (VI), they provide the benefit of being produced more easily and at lower expense than the crosslinking compounds of formula (III), as such crosslinking compounds can be prepared using less harsh chemicals than those used to prepare the crosslinking compounds of formula (III) while being at least as effective in crosslinking organic polymers as compounds of formula (III).

The crosslinkable polymer composition of the present invention may include a blend of one or more crosslinking compounds. In another embodiment, the crosslinkable polymer composition includes a single crosslinking compound that can be selected based upon the aromatic polymer of the crosslinkable polymer composition.

In a further embodiment, the crosslinking compound of the crosslinkable polymer composition of the present invention has a structure according to one of the following formulae:

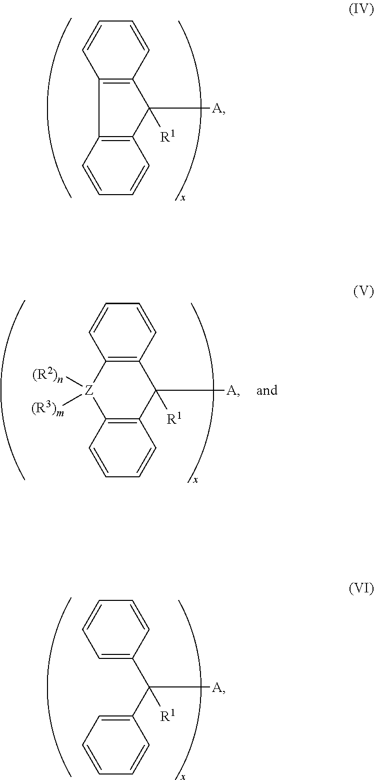

In each of formulae (IV)-(VI), A is bond, an alkyl, an aryl, or an arene moiety having a molecular weight less than about 10,000 g/mol. A molecular weight of less than about 10,000 g/mol permits the overall structure to be more miscible with the aromatic polymer, and permits uniform distribution, with few or no domains, within the blend of the aromatic polymer and crosslinking compound. More preferably, A has a molecular weight from about 1,000 g/mol to about 9,000 g/mol. Most preferably, A has a molecular weight from about 2,000 g/mol to about 7,000 g/mol.

The moiety A may be varied to have different structures, including, but not limited to the following:

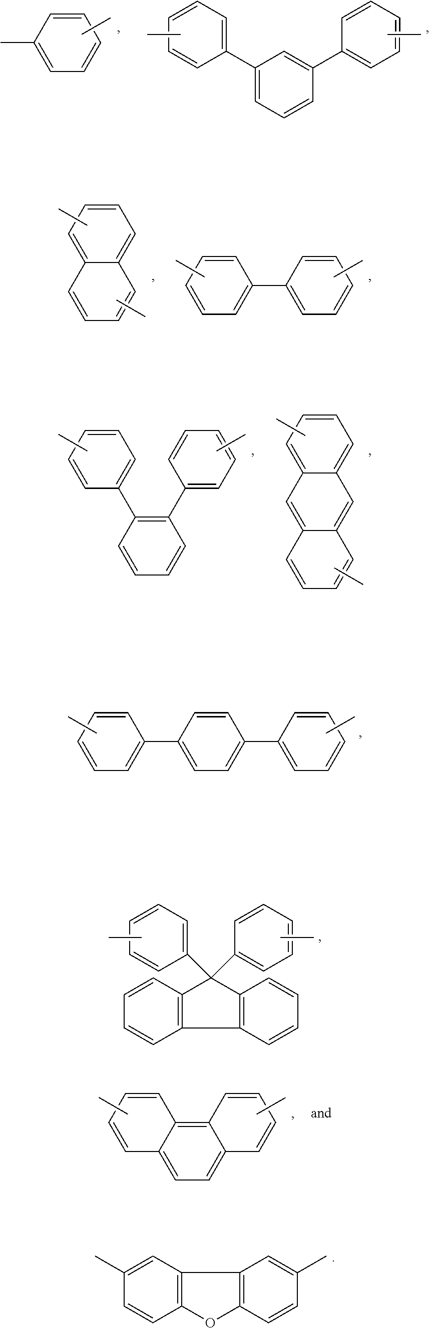

Further, the moiety A may be functionalized, if desired, using one or more functional groups such as, for example, and without limitation, sulfate, phosphate, hydroxyl, carbonyl, ester, halide or mercapto or the other functional groups noted above.

In formulas (IV) and (VI), R¹ is selected from the group consisting of hydrogen, hydroxyl (—OH), amine (NH₂), halide, ester, ether, amide, aryl, arene, or a branched or straight chain, saturated or unsaturated alkyl group of one to about six carbon atoms. In formula (V), R¹, R², and R³ are the same or different and are independently selected from the group consisting of hydrogen, hydroxyl (—OH), amine (NH₂), halide, ester, ether, amide, aryl, arene, or a branched or straight chain, saturated or unsaturated alkyl group of one to about six carbon atoms. Thus, R¹, R², and R³ may each be different, two of R¹, R², and R³ may be the same with the third being different, or each of R¹, R², and R³ may be the same. Further, in formula (V), m is from 0 to 2, n is from 0 to 2, and m+n is greater than or equal to zero and less than or equal to two. Thus, in formula (V), one or two R² groups may be present, one or two R³ groups may be present, one R² group and one R³ group may be present, or R² and R³ may both be absent. In formula (V), Z is selected from the group of oxygen, sulfur, nitrogen, and a branched or straight chain, saturated or unsaturated alkyl group of one to about six carbon atoms. In any of formulas (IV)-(VI), x is about 1 to about 6.

In embodiments having a crosslinking compound according to formula (IV), the crosslinking compound may have a structure according to one or more of the following:

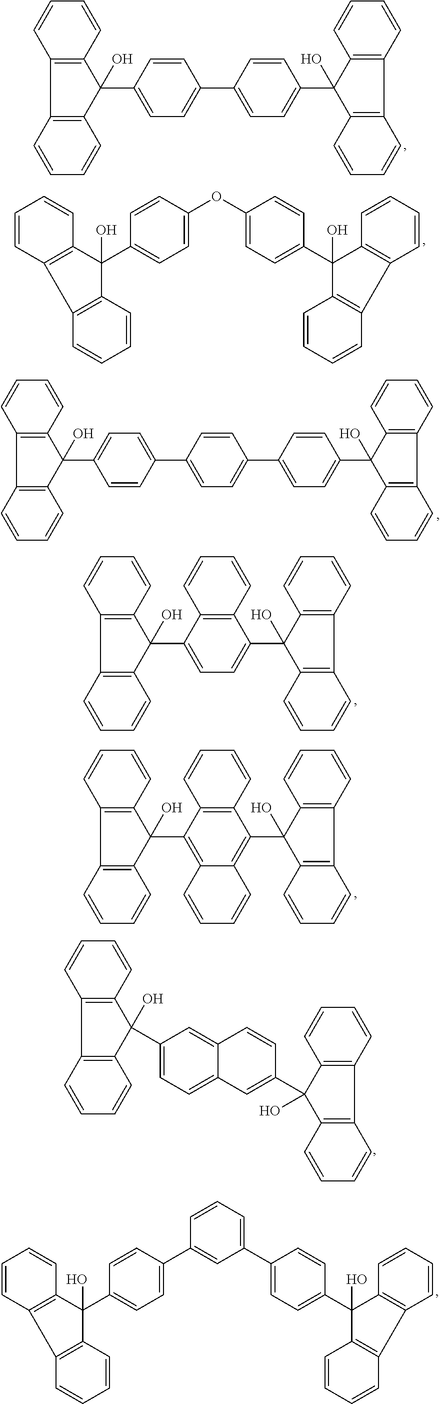

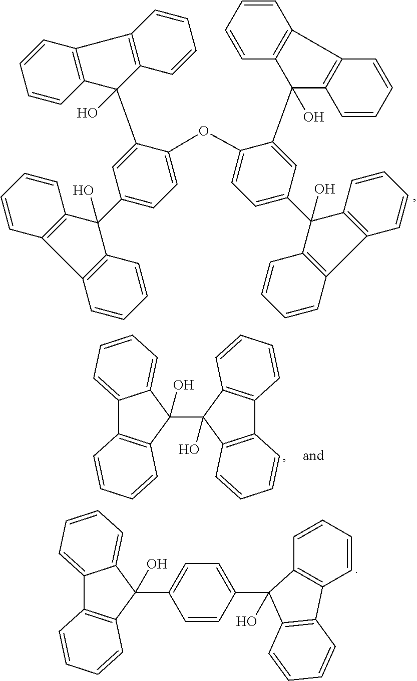

The above-listed crosslinking compounds are not intended to be limiting and are merely provided as examples of crosslinking compounds according to formula (IV). In the above compounds of formula (IV), R¹ is shown as being a hydroxyl group. The moiety, A, is shown as being any of various aryl groups, and x is shown as being either 2 or 4.

In embodiments having a crosslinking compound of formula (V), the crosslinking compound may have a structure according to one or more of the following:

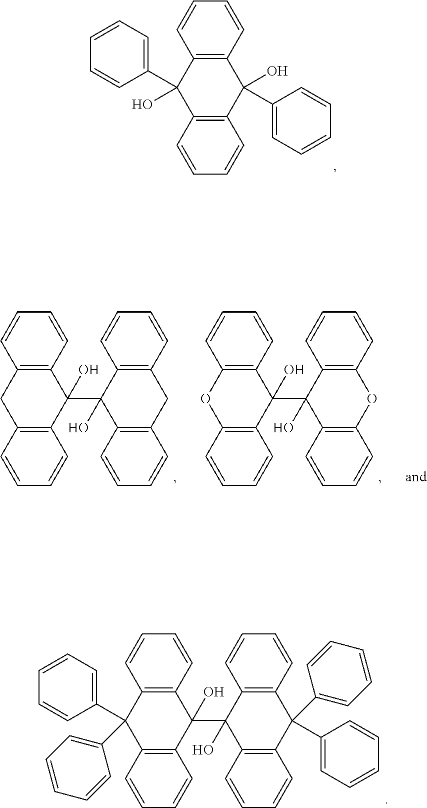

The above-listed crosslinking compounds are not intended to be limiting and are merely provided as examples of crosslinking compounds according to formula (V). In the aobve compounds of formula (V), Z is shown as being an alkyl group with one carbon atom or O. R¹ is shown as being a hydroxyl group. R² and R³ are shown as being the same, different or not present. The moiety A is shown as being a bond or an aryl group. Further, x is shown as being 1 or 2.

In embodiments in which the crosslinking compound has a structure according to formula (VI), the crosslinking compound may have one or more of the following structures:

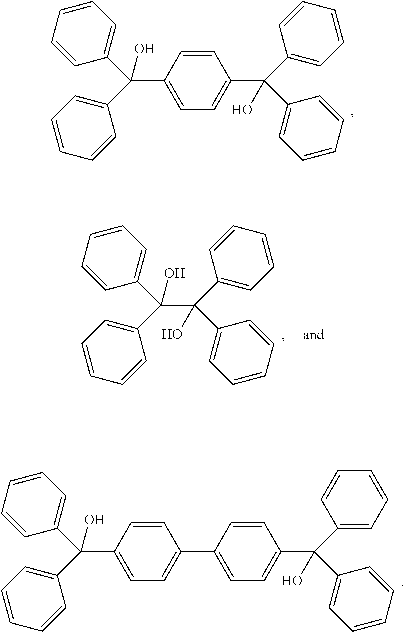 [SMILES: OC(c1ccccc1)(c1ccccc1)c1ccc(C(O)(c2ccccc2)c2ccccc2)cc1 ; OC(c1ccccc1)(c1ccccc1)C(O)(c1ccccc1)c1ccccc1 ; OC(c1ccccc1)(c1ccccc1)c1ccc(-c2ccc(C(O)(c3ccccc3)c3ccccc3)cc2)cc1]

The above-listed crosslinking compounds are not intended to be limiting and are merely provided as examples of crosslinking compounds according to formula (VI). In the above compounds of formula (VI), R¹ is shown as a hydroxyl group. The moiety A is shown as being a bond or an aryl group. Further, x is shown as being 2.

The amount of crosslinking compound(s) in the crosslinkable polymer composition is/are (collectively) preferably about 1% by weight to about 50% by weight, 5% by weight to about 30% by weight or about 10% to about 35%, or about 8% by weight to about 24% by weight based on the total weight of the unfilled crosslinkable polymer composition.

The crosslinkable polymer compositions of the present invention may have a weight ratio of the aromatic polymer to the crosslinking compound that is about 1:1 to about 100:1. More preferably, the weight ratio of the aromatic polymer to the crosslinking compound is about 3:1 to about 10:1.

The crosslinkable polymer compositions may optionally further include a crosslinking reaction additive for controlling the cure reaction rate during melt processing and post-treatment. Depending upon the cure reaction kinetics of a particular aromatic polymer and crosslinking compound, the crosslinking reaction additive can be a cure inhibitor (a Lewis base agent), such as lithium acetate, or the crosslinking reaction additive may be a cure accelerator (a Lewis acid agent), such as magnesium chloride or other rare earth metal halides. When the crosslinkable polymer composition includes a crosslinking reaction additive, the amount of crosslinking reaction additive in the crosslinkable polymer composition is preferably about 0.01% to about 5% by weight based on the weight of the crosslinking compound.

The crosslinkable polymer composition may further be filled or reinforced with one or more additives to improve the modulus, impact strength, dimensional stability, heat resistance and electrical properties of articles formed using the crosslinkable polymer composition. Preferably, the additive is selected from one or more of continuous or discontinuous, long or short, reinforcing fibers selected from one or more of carbon fibers, glass fibers, woven glass fibers, woven carbon fibers, aramid fibers, boron fibers, polytetrafluoroethylene (PTFE) fibers, ceramic fibers, polyamide fibers, and/or one or more fillers selected from carbon black, silicate, fiberglass, calcium sulfate, boron, ceramic, polyamide, asbestos, fluorographite, aluminum hydroxide, barium sulfate, calcium carbonate, magnesium carbonate, silica, aluminum nitride, borax (sodium borax), activated carbon, pearlite, zinc terephthalate, graphite, graphene, talc, mica, silicon carbide whiskers or platelets, nanofillers, molybdenum disulfide, fluoropolymer fillers, carbon nanotubes and fullerene tubes.

The additive preferably includes a reinforcing fiber which is a continuous or discontinuous, long or short fiber, that is carbon fiber, PTFE fiber, and/or glass fiber. Most preferably, the additive is a reinforcing fiber that is a continuous, long fiber. The crosslinkable polymer composition comprises about 0.5% to about 65% by weight of additives in the composition, and more preferably about 5% to about 40% by weight of additives in the composition. The crosslinkable polymer composition may further comprise one or more of stabilizers, flame retardants, pigments, colorants, plasticizers, surfactants, or dispersants.

The additives may additionally or alternatively include thermal management fillers, including but not limited to nanodiamonds and other carbon allotropes, polyhedral oligomeric silsesquioxane (“POSS”) and variants thereof, silicon oxides, boron nitrides, and aluminum oxides. The additives may additionally or alternatively include flow modifiers, such as ionic or non-ionic chemicals.

The present invention further relates to methods for preparing a crosslinkable polymer composition useful in and for additive manufacturing processes as well as methods of preparing an additive manufacturing composition including such polymers. The method for preparing the crosslinkable polymer composition includes providing an aromatic polymer and a crosslinking compound capable of crosslinking the aromatic polymer, and combining the aromatic polymer and the crosslinking compound. The composition including the combined aromatic polymer and crosslinking compound is preferably substantially homogeneous.

Combining the crosslinking compound or compounds into the aromatic polymer can be performed by means of various methods, such as by solvent precipitation, mechanical blending or melt blending. Preferably, the crosslinkable polymer composition is formed by dry powder blending of the crosslinking compound and aromatic polymer, such as by conventional non-crosslinked polymer compounding processes including, for example, twin-screw compounding. The resulting composition can be extruded into filaments or can be used as a powder or pellets. Blending may be accomplished by means of an extruder, such as a twin-screw extruder, a ball mill, or a cryogrinder. Blending of the aromatic polymer and crosslinking compound(s) is preferably conducted at a temperature during blending that does not exceed about 250° C. so that premature curing does not occur during the blending process. If a melt process is required, care must be taken to ensure thermal history and temperature exposure are minimized, i.e., it is preferred to use short residence times and/or as low temperature as feasible to achieve material flow. Alternatively, use of rate controlling additives may be used to inhibit curing and/or control the curing rate to minimize any crosslinking due to compounding and conversion into pellet or fiber form. Suitable crosslinking additives are known in the art and are described in U.S. Pat. No. 9,109,080 of the present applicant, which is incorporated herein in relevant part with respect to cross-linking control additives.

The blending process may be exothermic and as a result it is necessary to control the temperature, which can be adjusted as necessary and depending upon the aromatic polymer selected. In mechanical blending of the aromatic polymer and crosslinking compound, the resulting crosslinkable polymer composition is preferably substantially homogenous in order to obtain uniform crosslinking. If desired, the resulting blend can be cured by exposure to a temperature greater than 250° C., for example a temperature of about 250° C. to 500° C.

Alternatively, the composition can be prepared by dissolving both the aromatic polymer and crosslinking compound in a common solvent and removing the common solvent via evaporation or by the addition of a non-solvent to cause precipitation of both the aromatic polymer and crosslinking compound from the solvent. For example, depending upon the aromatic polymer and crosslinking compound selected, the common solvent may be tetrahydrofuran, and the non-solvent may be water.

In making the crosslinkable polymer composition, it is preferred that any optional additives are added to the composition along with or at the same time the crosslinking compound is combined with the aromatic polymer to make the crosslinkable polymer composition. However, the specific manner of providing reinforcing fibers or fillers may be according to various techniques for incorporating such materials and should not be considered to limit the scope of the invention.

The crosslinkable polymer compositions of the present invention as noted above are also suitable as additive manufacturing compositions and can include any suitable additives that are otherwise used in such processes as are known in the art, which further components may be blended along with other crosslinkable composition additives using the techniques noted herein.

The crosslinkable aromatic compositions and additive manufacturing compositions incorporating such crosslinkable aromatic compositions herein can be used in any of various additive manufacturing processes, including but not limited to three-dimensional printing, vat photopolymerization methods such as stereolithography (“SLA”), material or binder jetting methods, powder bed fusion methods such as selective laser sintering (“SLS”), and material extrusion methods such as fused deposition modeling (“FDM”), fused-filament fabrication (“FFF”) and direct pellet extrusion, among others. Preferably, the additive manufacturing process is a powder bed fusion method, such as SLS, or a material extrusion method, such as FFF or direct pellet extrusion.

For use in SLS, the crosslinkable polymer compositions and additive manufacturing compositions herein may be provided in a powder form. In SLS, a computer model of an article to be produced represents the article as a plurality of layers or cross sections. The article based on the computer model can be produced by depositing a layer of the powder on a build platform and selectively sintering the layer of powder, such as by means of a laser, to form a first layer of the article. After a first layer is formed by sintering, the build platform is incrementally lowered and a subsequent layer of powder is deposited on top of the first layer. The subsequent layer of powder is sintered to form a subsequent layer of the printed article. This process is repeated until the printed article is fully formed. The fully formed article can then be subjected to any of various finishing processes such as a thermal cure or a surface treatment, such as application of a coating, among others.

In FDM or FFF processes, the crosslinkable polymer composition and additive manufacturing compositions herein can be provided in the form of a filament. Similar to SLS, a computer model of the article can be provided and the computer model represents the article as a plurality of layers or cross sections. The article is formed in a layer-by-layer manner as the filament is fed to an extruding head which heats the filament so that it can be deposited on a build platform to form a layer of the article based on the computer model of the article. Once deposited, the heated filament hardens so as to form a layer of the article. A subsequent layer of filament is deposited on the first layer of filament to form a subsequent layer of the article based on the computer model of the article. This process is repeated until all layers of the article are deposited so as to form the printed article. Once the article is complete, various finishing processes may be performed, such as a thermal cure of the article, or surface treatments, such as sanding to remove excess material.

When used in an additive manufacturing process to form a printed article as described herein, the crosslinkable polymer composition (whether used alone or in an additive manufacturing composition) is preferably crosslinked by thermal action, such as by heating the polymer composition to a temperature to induce crosslinking of the aromatic polymer by the crosslinking compound. The crosslinkable polymer composition as provided for use in an additive manufacturing process may be crosslinked to some extent prior to use in additive manufacturing, but is preferably substantially uncrosslinked prior to use in an additive manufacturing process. Where the crosslinkable polymer composition is provided having some crosslinking prior to use in additive manufacturing, the crosslinking may be achieved during preparation of the crosslinkable polymer compsition into a form suitable for additive manufacturing, such as during pelletization of the crosslinkable polymer composition.

At least some crosslinking of the aromatic polymer in the crosslinkable polymer composition occurs during the formation of the individual layers in the additive manufacturing process. For example, in SLS, sintering via a laser may provide the heat to induce crosslinking of the polymer composition, and in FFF or FDM the extrusion head which heats the filament may provide the heat necessary to induce crosslinking. Such crosslinking during the additive manufacutring process is believed to improve interlayer adhesion in the z-direction of the article.

Additionally and preferably, once the printed article is fully formed by the additive manufacturing process, a final thermal cure step is undertaken in which the printed article may to promote further crosslinking. Such thermal cure step may be carried out in an autoclave, preferably over an extended time. The temperatures and times desired may be varied depending on the aromatic polymer selected as well as the degree of crosslinking desired and the presence or absence of catalysts or crosslinking additives, as well as the degree of crosslinking already carried out in the additive manufacturing initial article formation step. The processing temperature will thus be dictated by the polymer and end properties desired. Preferably, the majority of the crosslinking of the crosslinkable polymer composition occurs during the final thermal cure of the printed article.

Crosslinking the aromatic polymer is believed to provide increased adhesion between layers of the printed article, which provides the printed article with improved isotropy in mechanical properties, such as tensile strength and modulus. In addition to improved mechanical properties as discussed above, the resulting printed articles composed of the crosslinked polymer composition are believed to have improved electrical properties, thermal properties, such as a higher glass transition temperature and heat deflection temperature (“HDT”), and chemical properties, such as resistance to various solvents and/or radiation resistance high temperature performance, relative to the use of the unmodified, uncrosslinked base polymers. For example, polyarylethers can generally be dissolved in N-Methyl-2-pyrrolidone (NMP), but crosslinked polyarylethers do not dissolve in NMP.

In additive manufacturing processes using conventional uncrosslinked polymers, the layers of a printed article are joined primarily by the intermixing or melting of layers into each other by polymer diffusion. The crosslinkable polymer compositions of the present invention when used to form a printed article have layers joined by polymer diffusion and additionally by the formation of bonds and/or crosslinks between layers of the printed article.

Principally, the improved interlayer adhesion in articles formed by the crosslinkable polymer composition of the present application is provided by the formation of crosslinking reactions between adjacent layers of the printed article. Additionally, self-condensation reactions of a crosslinking compound in a first layer with a crosslinking compound in an adjacent layer of the printed article are believed to contribute to and to facilitate and/or enhance interlayer adhesion. In embodiments in which the crosslinking compound includes hydroxyl functionality, i.e., embodiments using a crosslinking compound having an R¹, R² or R³ group that is a hydroxyl group, the hydroxyl functionality may further contribute to increased interlayer adhesion due to the polarity of the hydroxyl group.

Crosslinking may occur within each printed layer and between adjacent layers of a printed article. The heat provided by the additive manufacturing process, such as the fusing of powdered material using a laser, may result in a greater amount of crosslinking occurring at the interface between layers relative to the amount of crosslinking occurring within a layer. However, the extent of crosslinking and the location of the crosslinking, either within a layer or at the interface of adjacent layers, depends upon various factors, including the type of polymer, the temperature, and the layer thickness.

The crosslinkable polymer compositions of the present invention may be used to prepare any of various printed articles. The printed articles formed from the crosslinkable polymer composition may be particularly useful as parts and articles of manufacture in extreme temperature environments. U.S. Pat. No. 9,006,353 B2, incorporated herein by reference in relevant part, describes improved high temperature performance of the crosslinked organic polymers therein, which crosslinked polymers have thermal stability up to about or greater than 500° C.

The crosslinkable polymer compositions of the present application may be used to form prototypes, parts and replacement parts for use in a variety of industries and in a variety of end applications, including oil and gas drilling and recovery, semiconductor processing, aerospace applications including aerospace sensor components and housings, electrical motor components, electronics enclosures, ducting and tubing for environmental control systems, structural brackets, engine components, automotive applications, medical devices and prosthetics, construction, and consumer products, among others. For example, in down-hole applications, the crosslinkable polymer composition may be used to form packaging; composite cells; connectors; sealing assemblies, including O-rings, V-rings, U-cups, gaskets, bearings, valve seats, adapters, wiper rings, chevron back-up rings; and tubing.

The crosslinking capability provided herein both across and throughout the layers of the article, which provide increased crosslink density, are believed to also contribute to solvent-, chemical- and radiation-resistance, physical properties (tensile strength and modulus, e.g.), electrical properties, thermal properties (Tg/HDT) and thermal-electrical properties.

The invention will now be further described with respect to the following non-limiting Examples.

### EXAMPLES

Crosslinkable PAEKs were used to form test specimens having different geometries, including different sized tensile bars and double cantilever beams (DCB). The specimens were formed by printing using various, open-source FFF three dimensional printers. The general printing conditions were use of a nozzle size at 0.4 mm, an extruder temperature at 360° C. to 425° C., a building plate temperature at 100° C. to 200° C., a chamber temperature at 50° C. to 150° C., a layer height of 0.1 to 0.4 mm, and a printing speed from 20 mm/s to 300 mm/s. The Examples of iso tensile bars and DCB beams according to the invention were printed at an extruder temperature at 360° C., a chamber temperature at 70° C., a plate temperature at 160° C., a layer height at 0.2 mm with printing speed at 40 mm/s using an Intamsys© Funmat HT™ 3D printer. The Examples of an American Standard Testing Method (ASTM) T1 bar were printed using an HSE HT three-dimensional printer with an extruder temperature at 425° C., a chamber temperature at 50° C., a plate temperature at 105° C., a layer height 0.2 mm, and printing speed of 30 mm/s. Specifics are detailed in the Examples that follow.

Injection molded bars prepared as a reference material in the various examples below were prepared using a cross-linked polyarylene, including a crosslinking compound and a crosslinking control additive as described in U.S. Pat. No. 9,109,080.

Injection molding of Arlon3000XT™ test specimens (ASTM D-638 (Type 1 tensile bars) and ASTM D-790 (flex bars)) was performed with an Arburg 44-ton hydraulic injection molding press and a hot sprue housing using commercially available Arlon3000XT™ pellets. A temperature profile as indicated in Table 1 was used and material was injected using the process settings as shown in Table 2.

TABLE 1

| | | | | | | | Hot | Hot |
|---|---|---|---|---|---|---|---|---|
| | Zone | Zone | Zone | Zone | Zone | Zone | Sprue | Sprue |
| | 1 | 2 | 3 | 4 | 5 | 6 | A | B |
| Temp | 675 | 675 | 675 | 675 | 675 | 675 | 675 | 675 |
| ° F. | | | | | | | | |

TABLE 2

| Re- | Back | Dose | Decom- | | Switch- | | | |
|---|---|---|---|---|---|---|---|---|
| covery | Pres- | Vol- | pres- | Injection | over | | | Cool- |
| Speed | sure | ume | sion | Velocity | Position | Packing | | ing |
| (ft/min.) | (psi) | (in³) | (in³) | (in³/s) | (in³) | (psi) | (sec) | (sec) |
| 30 | 700 | 1.8 | 0.1 | 0.35 | 0.3 | 12000 | 30 | 30 |

Injection pressure was kept to not exceed 13,000 psi and the material cushion was 0.1 in³, for an average cycle time of 75 seconds.

### Example 1

### Enhanced Interlayer Bonding Using Crosslinkable Polymer Composition

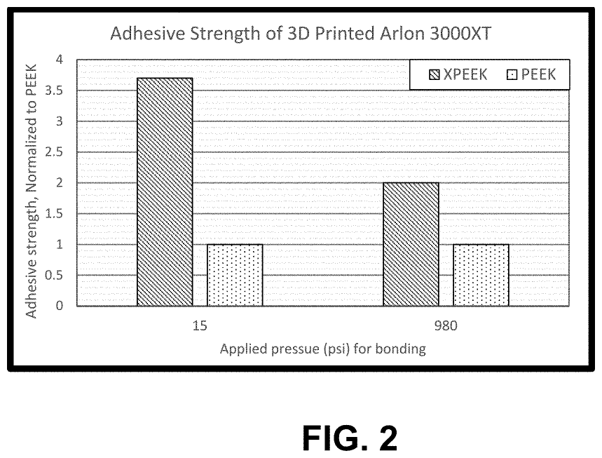

Injection molded flex bars were prepared from commercially available crosslinkable Arlon 3000 pellets (a 5000 grade PAEK with a cross-link compound formulation). Areas to be placed in contact for the bonding experiment were polished by sandpaper to remove any contamination from the skin layer of the specimens. Bars were overlapped to form a lap-shear test coupon with overlap area 3×0.5 in². Self-adhesion tests were performed according to ASTM D-3163 in a vacuum bag to generate 15 psi contact pressure and in a compression set block to generate 980 psi pressure. Test specimens were subject to Arlon 3000XT™ post-cure cycle to activate the cross-linking agent, and after the cycle, the adhesion test was performed on both cured specimens and uncured specimens. Adhesion strength was calculated as force at failure divided by contact area and the results can be seen in FIG. 2.

After post-cure, cross-linking between layers increased the strength of the bond by over 350%, indicating improved inter-layer adhesion compared to a non-crosslinked injection molded part.

### Example 2

### Creation of Crosslinkable Filament Via Twin Screw Extrusion

To create filament for a post-fabrication, cross-linking-capable three-dimensional printing pellets were prepared from a crosslinkable blend of a polyetherether ketone (PEEK) material containing 17% of a crosslinking compound of Example 2 of U.S. Pat. No. 9,006,353 as a chemical cross-linker, 0.1% lithium acetate for controlling crosslinking with the bulk of the remaining compound consisting of a high-viscosity 5000P PAEK compounded on a twin screw extruder, and commercially available as Arlon 3000XT™ pellets. See, U.S. Pat. Nos. 9,006,353 and 9,109,080 for details on such materials, each of which are incorporated herein, in relevant part.

To convert the material into filament, the pellets were fed into a second twin-screw extruder with screw length to diameter (L/D) ratio of 46:1, D=1″ (25 mm), and 10 heated zones, which was used with a screw profile consisting of primarily transport (conveying) elements and a mixing section located before a vent port. The material was side-fed four zones downstream via a reciprocating (screw) feeder for an effective L/D of 36:1.

The following extruder temperature profile, i.e., heat profile (in ° C.) was used on the extruder, with a 10-20C.° range on each zone:

TABLE 3

| | Die | Zone 9 | Zone 8 | Zone 7 | Zone 6 | Zone 5 | Zone 4 |
|---|---|---|---|---|---|---|---|
| Set | 370 | 370 | 370 | 370 | 360 | 340 | 290 |
| Point | | | | Vent | | | Feed |

The material was dried at 250° F. (120° C.) for a minimum of 4 hours prior to extrusion.

Screw speeds of 75 rpm were used to match a feed rate of material of 5-7 kg/hr. The output was 5 kg/hr during the initiation of spools, and was ramped up to 7 kg/hr once the spooling began.

Extrudate was drawn by pullers and cooled through a series of air and water baths to achieve a target filament diameter of 1750±75 μm and ovality of 0+0.1 ovality, where ovality is the absolute value of the difference between the average of three diameter measurements taken by laser and the largest measurement.

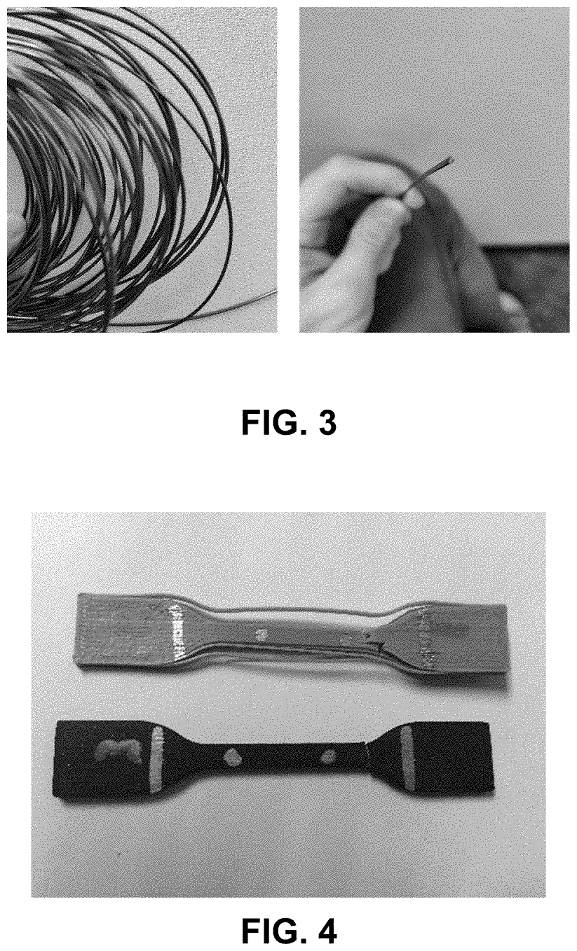

Using the above process, approximately 5,430 ft (1650 m) of filament weighing approximately 5 kilograms was fabricated for use in three-dimensional printing. Sample filament is shown in FIG. 3.

### Example 3

### Filament Extrusion by Single Screw Extruder

Commercially available crosslinkable PAEK pellets, as in Example 1, were melt extruded by single screw to produce filaments. A ¾″ single screw extruder was used in this Example. The general processing conditions are shown below in Table 4. The preferred extruder conditions of Example 2 were used as the extruder temperature and the die temperature was at 350° C. The extrude speed was about 40 rpm.

TABLE 4

| Extruder | Value |
|---|---|
| Screw Diameter (in.) | ¾ |
| L/D | 16:1 |
| Screw Compression Ratio | 3:1 |
| Extruder Temperature (° C.) | 300-400 |
| Die Temperature (° C.) | 300-400 |
| Speed (rpm) | 10-50 |

The filaments obtained met the requirements for three-dimensional printing industrial specifications and are qualified for three-dimensional printing.

### Example 4

### FFF Three-Dimensional Printed Articles from Cross-Linkable Filaments Showing Improved Properties and Improved Interlaminar Strength

Three-dimensional printed tensile bars were subjected to the same post-cure cycle and tested for tensile strength and modulus according to ASTM D-638. A double cantilever beam (DCB) test was also performed on cured and uncured specimens according to ASTM D-5528 to determine interlaminar resistance to crack initiation and propagation. The specimens for the DCB test were dimensioned according to the standard. During the printing process, 30 μm thick Kapton tape was inserted at the mid-plane to introduce an opening, and was removed after the printing process was completed. A razor blade was used to expand the opening to the desired pre-crack length as per ASTM D-5528. The measured value was energy dissipated per unit area of crack growth, GI (adhesive fracture energy). The results of both tests are shown in Table 5 (showing RT tensile properties and adhesion energy of 3D printed Arlon 3000XT™), normalized to an uncured specimen, and are shown as example specimens after the DCB test in FIG. 4. With reference to FIG. 4, the top specimen shown is formed of Standard FFF PEEK and the bottom test specimen is formed of the crosslinkable formula using Arlon 3000XT™. It is noted that the top, standard prior art sample has delamination when printed under the same conditions as were used to make the crosslinked material.

TABLE 4

| | RT Tensile | RT Tensile | Adhesion |
|---|---|---|---|
| Material | Strength | Modulus | Energy |
| PEEK | 100% | 100% | 100% |
| Arlon 3000XT ™ | 128% | 122% | 169% |

Post-curing the samples resulted in an about 25% increase in tensile properties, a 70% increase in the energy required to propagate a crack in between the three-dimensionally printed layers and a significant reduction in delamination of the layers.

Three-dimensional printed specimens were also compared to their injection molded counterparts to demonstrate the improvement in properties when cross-linked in Table 5.

TABLE 5

| Ratio 3D Printed to Injection | RT Tensile | RT Tensile |
|---|---|---|
| Molded Bars | Strength | Modulus |
| PEEK | 87% | 76% |
| Arlon 3000XT ™ | 94% | 98% |

Crosslinking the three-dimensionally printed parts resulted in an elimination of the loss of properties (also sometimes referred to as “property knockdown”) exhibited by uncrosslinked PAEKs in three-dimensional printed form versus their properties when formed into articles by conventional injection molding, believed to be attributable to the printing process.

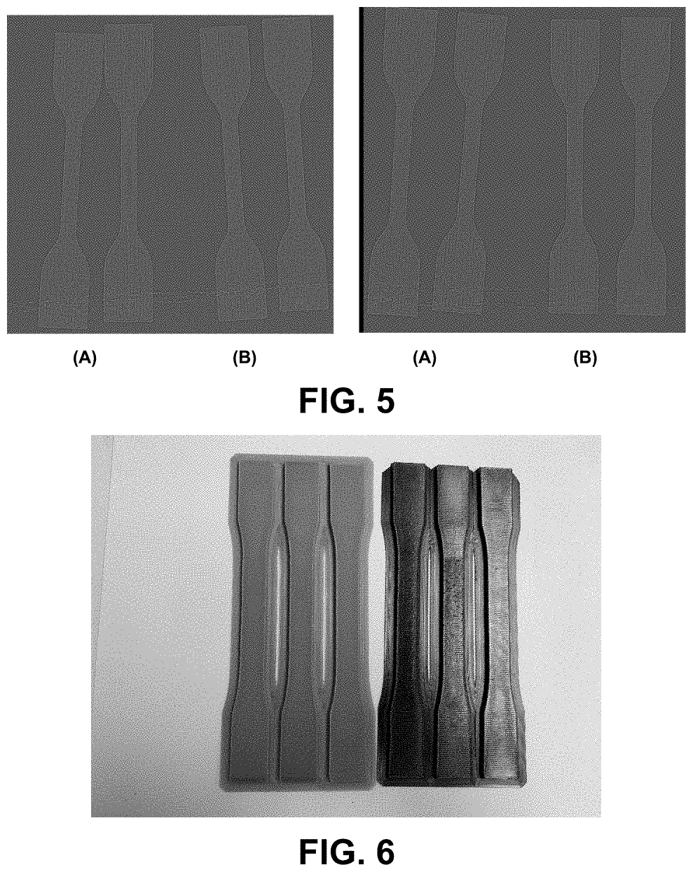

Two-dimensional CT scan images of the three-dimensionally printed PEEK and Arlon 3000XT™ bars are shown in FIG. 5 before and after the post-cure cycle. In FIG. 5, on the left 2D CT scan are the PEEK (A) and crosslinkable Arlon 3000 (B) before post-curing, and on the right are the PEEK (A) and Arlon 3000XT™ after post-curing. This demonstrates that there was no detectable porosity in the cross-linked printed articles, either before or after post-curing.

### Example 5

### FFF Printed Bars of Crosslinkable PAEK

Three-dimensionally printed ASTM T1 bars of PEEK and Arlon 3000 in YX orientation were made on a commercial high-temperature polymer FFF printer. The printing conditions were as follows: extruder temperature 360° C. to 425° C.; build plate temperature 100° to 200° C.; chamber temperature 50° C. to 150° C.; layer height 0.1 to 0.4 mm; printing speed: 20 to 300 mm/s. The bars formed are shown in FIG. 6. In FIG. 6, the bars on left represent the FFF printed PAEK bars, and the bars on right are the crosslinkable PAEK bars which were formed using filaments prepared under the conditions referenced in Examples 1 and 2.

### Example 6

### Improved Processability of Crosslinkable PAEK Formulas for 3D Printing Applications

The rheological behavior of crosslinkable PAEK and standard PAEK and PEEK pellets were evaluated by making preforms on an ARES G2 rheometer (from TA Instruments) using 25 mm parallel plate geometry. The rheological behavior of pellet change with time at 380° C. under N₂ was recorded. The oscillation condition was selected as 0.1% strain/1 Hz.

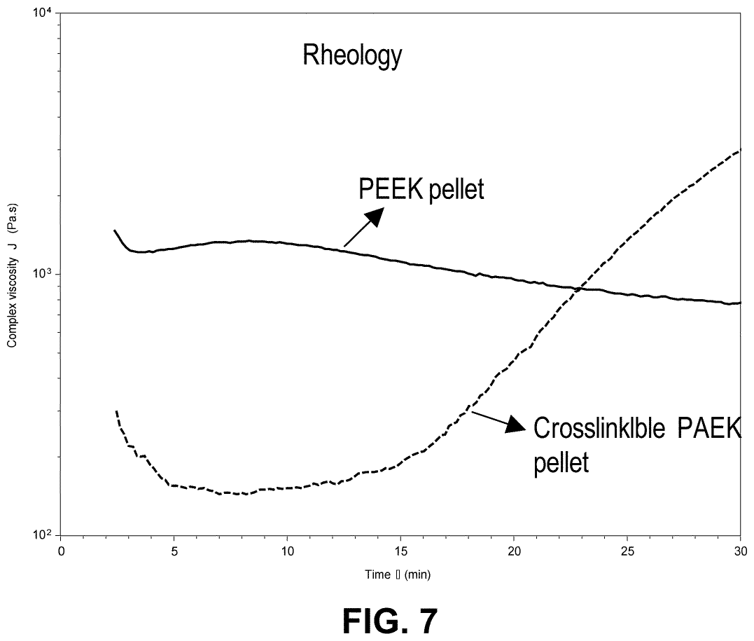

FIG. 7 shows the rheology scan of the crosslinkable PAEK and the standard PAEK. The crosslinkable formula has a significantly lower viscosity, indicating better melt-processability on the order of processing time. Cross-linking begins after 15 minutes and after 24 minutes cross-linking has progressed to the point where viscosity exceeds that of neat PEEK (FIG. 7).

The thermal transition behavior of Arlon 3000XT™ and PEEK filaments were studied by DSC (Discovery, TA instruments). Heat/cool/heat cycle was selected. The crystallization temperature in the cool stage and the glass transition temperature in second heat were recorded. The first heat temperature was to 380° C. at 20° C./min, followed by the cool to 50° C. at 10° C./min, and then the second heat to 400° C. at 20° C./min.

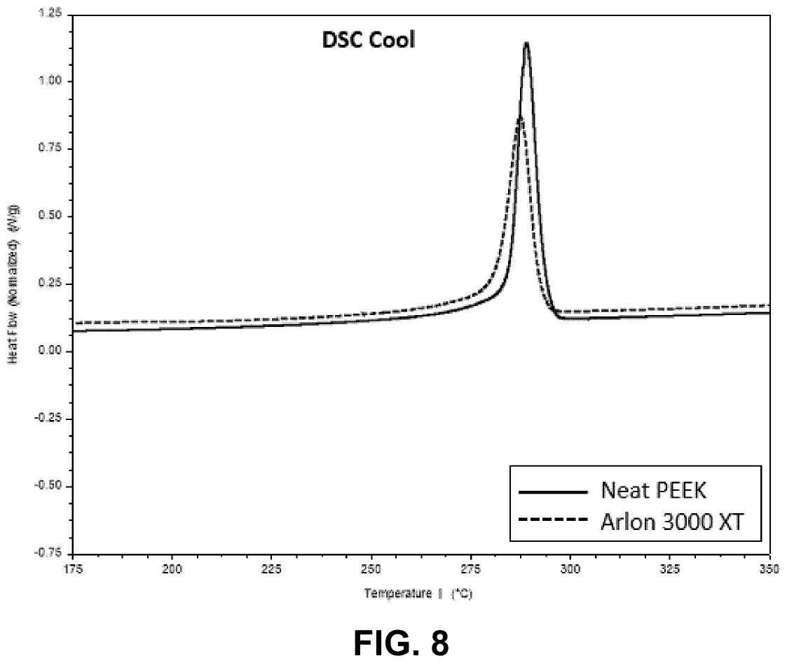

FIG. 8 shows the cooling curve in DSC for the same materials. Note there is a slower onset of crystallization for the Arlon 3000XT™, as well as a lower enthalpy (peak area). The data in FIG. 8 shows a lower T_{g} (148° C. in Arlon 3000XT™ v. 152° C. in PEEK) and a reduced crystallization temp (indicating a slower crystallization rate; 287° C. in crosslinkable PAEK v. 289° C. in standard PEEK). These properties are very helpful for improved processability. For example, PEKK materials that designed to crystallize more slowly (Arkema™ Kepstan™ 6002, which has a low ether/ketone ratio and a copolymer structure with terephthalic and isophthalic monomers) to reduce chain regularity and inhibit crystallization (See, Kepstan™ 6000 Datasheet:

https://www.arkema.com/expport/shared/.content/media/downloads/products-documentations/incubator/arkema-kepstan-6000-tds df).

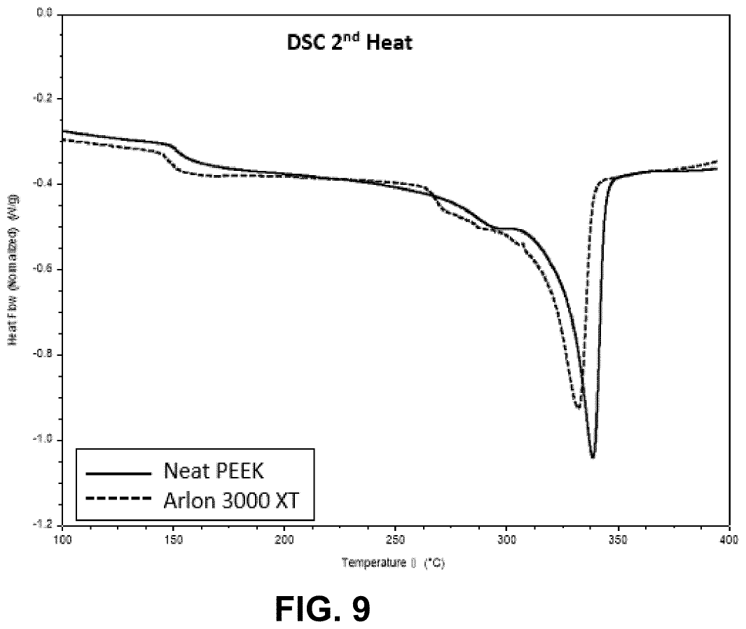

FIG. 9 provides the heating curve of the DSC of the filament showing crosslink capability via the T_{g} shift on the second heat, which is indicative of thermal properties after printing and postcuring of three-dimensionally printed articles from the crosslinked formula.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1. A crosslinkable polymer composition for use in an additive manufacturing method, comprising:
at least one aromatic polymer, and at least one crosslinking compound capable of crosslinking the at least one aromatic polymer.

2. The crosslinkable polymer composition according to claim 1, wherein the at least one aromatic polymer is selected from poly(arylene ether)s, polysulfones, polyethersulfones, polyimides, polyamides, polyetherketones, polyphenylene sulfides, polyureas, polyurethanes, polyphthalamide, polyamide-imides, poly-benzimidazoles, polyaramids, and blends thereof.

3. The crosslinkable polymer composition according to claim 2, wherein the at least one aromatic polymer is a poly(arylene ether) including polymer repeating units along its backbone having the structure according to formula (I): 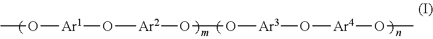
wherein Ar¹, Ar², Ar³ and Ar⁴ are identical or different aryl radicals, m=0 to 1, and n=1−m.

4. The crosslinkable polymer composition according to claim 3, wherein the at least one aromatic polymer has repeating units along its backbone having the structure of formula (II):

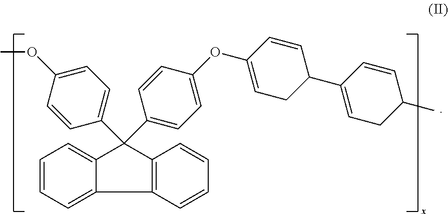

5. The crosslinkable polymer composition according to claim 1, wherein the at least one aromatic polymer is a polyarylene ether or a polyaryletherketone.

6. The crosslinkable polymer composition according to claim 5, wherein the polyaryletherketone is selected from the group of polyetherketone, polyetheretherketone, polyetherketoneketone, and polyetherketoneetherketoneketone.

7. The crosslinkable polymer composition according to claim 1, wherein the at least one crosslinking compound has a structure according to one of the following formulae: 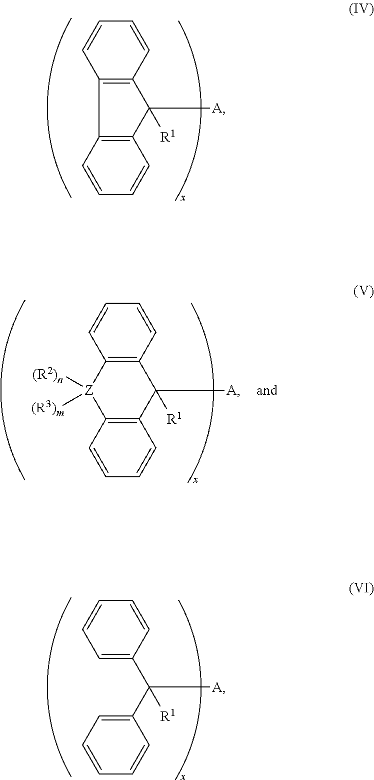
wherein A is a bond, an alkyl, an aryl, or an arene moiety having a molecular weight less than about 10,000 g/mol; wherein R¹, R², and R³ are the same or different and are independently selected from the group consisting of hydrogen, hydroxyl (—OH), amine (NH₂), halide, ester, ether, amide, aryl, arene, or a branched or straight chain, saturated or unsaturated alkyl group of one to about six carbon atoms; wherein in is from 0 to 2, n is from 0 to 2, and m+n is greater than or equal to zero and less than or equal to two; wherein Z is selected from the group of oxygen, sulfur, nitrogen, and a branched or straight chain, saturated or unsaturated alkyl group of one to about six carbon atoms; and wherein x is about 1 to about 6.

8. The crosslinkahle polymer composition according to claim 7, wherein the at least one crosslinking compound has a structure according to formula (IV) and is selected from the group consisting of:

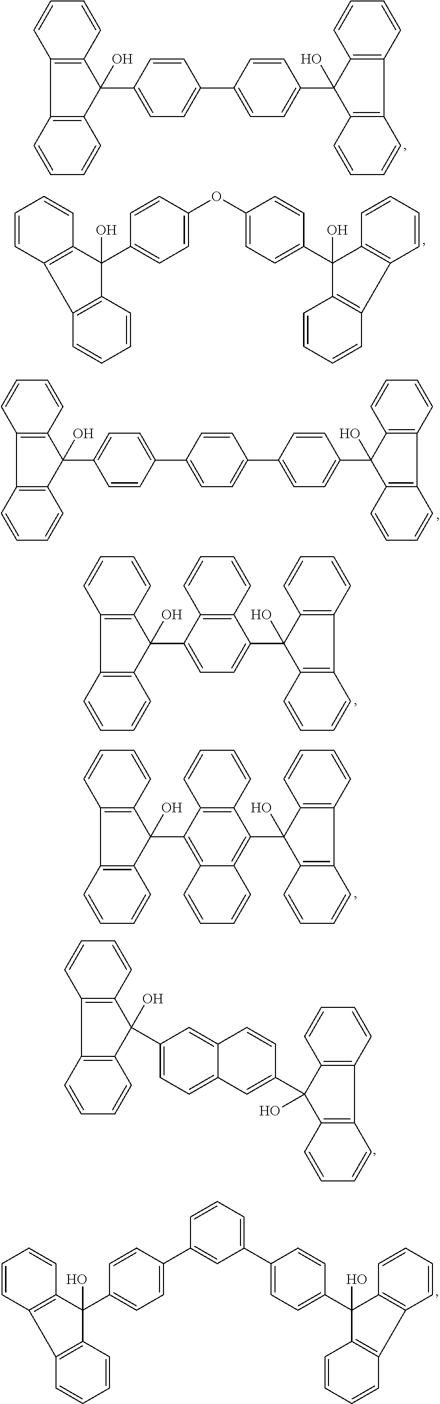

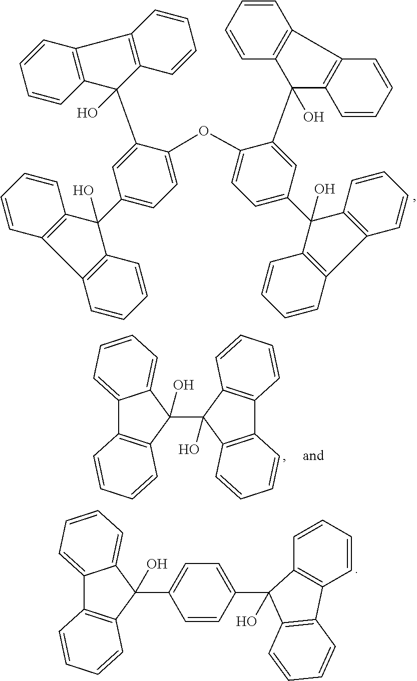

9. The crosslinkable polymer composition according to claim 7, wherein the at least one crosslinking compound has a structure according to formula (V) and is selected from a group consisting of:

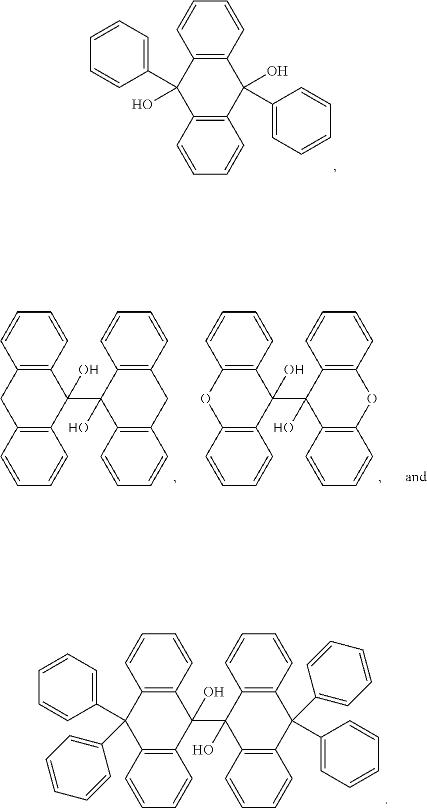

10. The crosslinkable polymer composition according to claim 7, wherein the at least one crosslinking compound has a structure according to formula (VI) and is selected from the group consisting of:

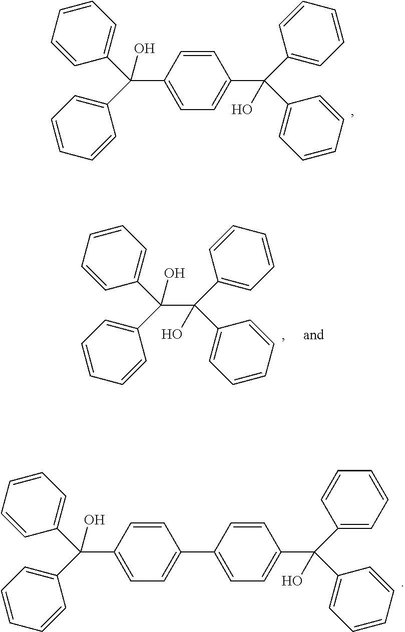 [SMILES: OC(c1ccccc1)(c1ccccc1)c1ccc(C(O)(c2ccccc2)c2ccccc2)cc1 ; OC(c1ccccc1)(c1ccccc1)C(O)(c1ccccc1)c1ccccc1 ; OC(c1ccccc1)(c1ccccc1)c1ccc(-c2ccc(C(O)(c3ccccc3)c3ccccc3)cc2)cc1]

11. The crosslinkable polymer composition according to claim 7, wherein A has a molecular weight of about 1,000 g/mol to about 9000 g/mol.

12. The crosslinkable polymer composition according to claim 11, wherein A has a molecular weight of about 2,000 g/mol to about 7,000 g/mol.

13. The crosslinkable polymer composition according to claim 1, wherein at least. one crosslinking compound is present in the crosslinkable polymer composition in an amount of about 1% by weight to about 50% by weight of an unfilled weight of the crosslinkable polymer composition.

14. The crosslinkable polymer composition according to claim 1, wherein a weight ratio of the aromatic polymer to the crosslinking compound is about 1:1 to about 100:1.

15. The crosslinkable polymer composition according to claim 14, wherein the weight ratio of the aromatic polymer to the crosslinking compound is about 3:1 to about 10:1.

16. The crosslinkable polymer composition according to claim 1, further comprising a crosslinking reaction additive selected from a cure inhibitor and a cure accelerator.

17. The crosslinkable polymer composition according to claim 16, comprising the crosslinking reaction additive in an amount of 0.01% to 5% by weight of the crosslinking compound.

18. The crosslinkable polymer composition according to claim 16, wherein the crosslinking reaction additive is a cure inhibitor and is lithium acetate.

19. The crosslinkable polymer composition according to claim 16, wherein the crosslinking reaction additive is a cure accelerator and is magnesium chloride.

20. The crosslinkable polymer composition according to claim 1, further comprising one or more additives selected from continuous or discontinuous, long or short, reinforcing fibers selected from carbon fibers, glass fibers, woven glass fibers, woven carbon fibers, aramid fibers, boron fibers, polytetrafluoroethylene fibers, ceramic fibers, polyamide fibers; and/or one or more fillers selected from carbon black, silicate, fiberglass, calcium sulfate, boron, ceramic, polyamide, asbestos, fluorographite, aluminum hydroxide, barium sulfate, calcium carbonate, magnesium carbonate, silica, aluminum nitride, borax (sodium borax), activated carbon, pearlite, zinc terephthalate, graphite, graphene, talc, mica, silicon carbide whiskers or platelets, nanofillers, molybdenum disulfide, fluoropolymer fillers, carbon nanotubes and fullerene tubes.

21. The crosslinkable polymer composition according to claim 20, wherein the polymer composition comprises about 0.5% by weight to about 65% by weight of the one or more additives and/or one or more fillers.

22. An article printed by an additive manufacturing process using the crosslinkable polymer composition according to claim 1.

23. The article of claim 22, wherein the article has improved interlayer adhesion relative to an article formed by an aromatic polymer having the same backbone structure that is not crosslinked

24. The article of claim 22, wherein the article has improved isotropy in mechanical properties relative to an article formed by an aromatic polymer having the same backbone structure that is not crosslinked.

25. The article of claim 22, wherein the article is formed by selective laser sintering.

26. The article of claim 22, wherein the article is firmed by fused filament fabrication.

27. A crosslinked composition formed from the composition according to claim 1, having a lower viscosity and a reduced crystallization rate in comparison to a composition formed of the same aromatic polymer but that is not cross-linked.

28. The crosslinked composition formed from the composition according to claim 1, wherein postcuring of the crosslinked composition into an article results in improved adhesive bonding between layers formed from printed filaments or formed by injection molding in comparison to an uncrosslinked composition formed of the same aromatic polymer.

29. An additive manufacturing composition for use in an additive manufacturing process, wherein the composition comprises the crosslinkable aromatic polymer composition according to claim 1.

30.-36. (canceled)

37. A method of preparing an article by an additive manufacturing process, comprising:
providing the crosslinkable polymer composition of claim 1; and
utilizing the crosslinkable polymer composition in an additive manufacturing process to prepare a printed article.

38. The method according to claim 37, wherein the additive manufacturing process is a powder bed fusion method.

39. The method according to claim 37, wherein the additive manufacturing process is a material extrusion method.

40. A method of improving adhesion between layers in an article prepared by an additive manufacturing process, comprising:
providing the crosslinkable aromatic polymer composition according to claim 1;
introducing the crosslinkable aromatic polymer composition into an additive manufacturing process to prepare a printed article; and
applying heat to the crosslinkable, aromatic polymer composition during and/or after the additive mamfacturing process to induce crosslinking of the aromatic polymer by the crosslinking compound.

41. A method of improving isotropy in mechanical properties of an article prepared by an additive manufacturing process, comprising:
providing the crosslinkable aromatic polymer composition according to claim 1;
introducing the crosslinkable aromatic polymer composition into an additive manufacturing process to prepare a printed article; and
applying heat to the crosslinkable aromatic polymer composition during and/or after the additive manufacturing process to induce crosslinking of the aromatic polymer by the crosslinking compound.

42. A method of improving processability of an aromatic polymer in an additive manufacturing process, comprising:
providing the crosslinkable aromatic polymer composition according to claim 1; and
introducing the crosslinkable aromatic polymer composition into an additive manufacturing process to prepare a printed article, whereby the composition exhibits a reduced viscosity in comparison to use of an aromatic polymer composition having the same aromatic polymer but lacking the at least one crosslinking compound.

43. A crosslinked polymer composition for use in an additive manufacturing method, comprising:
at least one aromatic polymer crosslinked by at least one of thermally-induced crosslinking, grafted crosslinking, and chemical crosslinking.

44. The crosslinked polymer composition for use in an additive manufacturing method according to claim 43, wherein the at least one aromatic polymer is chemically crosslinked and the composition further comprises at least one crosslinking compound capable of crosslinking the at least one aromatic polymer.
